(19) United States
(12) Patent Application Publication
(10) Pub. No.: US 2026/0242987 A1
(43) Pub. Date: Aug. 20, 2026

(54) Fabric And Use Of The Fabric In Protective Clothing For Firefighting

(71) Applicant: IBENA Textilwerke GmbH, Bocholt (DE)

(72) Inventor: Britta Smeulders, Lichtenvoorde (NL)

(21) Appl. No.: 19/544,651

(22) Filed: Feb. 19, 2026

(30) Foreign Application Priority Data
Feb. 20, 2025 (EP) 25158996.6

(51) Int. Cl. D03D 15/513; D03D 15/225; D03D 15/533; D03D 15/573

(52) U.S. Cl. CPC D03D 15/513; D03D 15/225; D03D 15/533; D03D 15/573; D10B 2201/24; D10B 2401/16; D10B 2501/04

(57) ABSTRACT

A fabric has a core yarn with a core consisting of 100% polyamide and a sheath of synthetic cellulose FR, optionally aramid, in particular para-aramid, and optionally antistatic fibers, the yarn optionally containing a total of 1-12% aramid, in particular para-aramid, 52-70% synthetic cellulose FR, 26-35% polyamide, and optionally up to 2% antistatic fibers. Furthermore, the use of such a fabric in protective clothing for firefighting in open terrain and/or for technical rescue is presented.

### CROSS-REFERENCE TO RELATED APPLICATIONS

This application claims priority to European Patent Application EP 25 158 996.6, filed Feb. 20, 2025.

### TECHNICAL FIELD

The invention relates to a fabric and the use of the fabric in protective clothing for firefighting in open terrain.

Such fabrics must not only be flame-retardant, but must also have sufficient strength. Furthermore, it is necessary that they shrink only slightly after a certain number of washing cycles and are also comfortable to wear.

### PRIOR ART

Such fabrics are known, for example, from EP 2 079 332 A1 and US 2005/0025962A1 . Furthermore, EP 3 831 992 A1 relates to a fabric with a core yarn in the warp direction, which comprises a core consisting entirely of polyamide and a sheath of synthetic cellulose FR and antistatic fibers. The fabric can be used for protective clothing for firefighting. A similar yarn with polyamide and a comparatively high proportion of aramid is apparent from CN 109 706 572 B and CN 109 629 060 B. A comparatively high proportion of aramid also applies with regard to CN 109 183 223 A, and CN 109 629 056 A constitutes further prior art. Similar fabrics are the fabrics according to EP 2 534 289 A2 and the fabric named Defender M mentioned therein.

The latter patent was aimed at improving the known Defender M, in particular with regard to abrasion resistance. The proportion of polyamide was increased for this purpose. However, this deteriorated the properties with regard to limited flame spread in terms of afterglow to such an extent that such a fabric could not be used for outdoor firefighting.

Both when new and after washing, the afterglow time in the warp direction and in the weft direction is 6.7 and 8 seconds, respectively, and thus lies clearly above the EN ISO 15384 performance requirement of </=2 seconds.

Furthermore, the used yarns were typical ring yarns, i.e. intimately blended yarns.

### SUMMARY OF THE INVENTION

Against this background, there is a need to improve the known fabrics in terms of abrasion resistance without deteriorating the limited flame spread in terms of afterglow to such an extent that the fabric is no longer suitable for the “firefighting in open terrain” standard.

This object is solved by the fabric described in patent claim 1.

Accordingly, it comprises a core yarn with a core consisting of 100% polyamide. The sheath comprises synthetic cellulose FR, aramid, in particular para-aramid, and optionally antistatic fibers, the yarn containing a total of 1-12% aramid, in particular para-aramid, 52-70% synthetic cellulose FR, 26-35% polyamide, and optionally up to 2% antistatic fibers. The strength is essentially ensured by the polyamide, in particular PA 6.6, in the core, which can be configured as a multifilament, for example. Thus, the proportion of (para-)aramid as strength-bearing material can be reduced, which has a favorable effect on manufacturing costs. It is to be mentioned at this point that the used aramid preferably has a total proportion of at least 4% and/or can be para-aramid and/or meta-aramid, however, the yarn can be free in particular of meta-aramid. The polyamide in the core is also preferably present in the form of a high-strength and shrunk filament yarn. Owing to the core/sheath yarn with polyamide in the core, the proportion of polyamide could even be set significantly higher than in EP 2 534 289 A2 without a deterioration in view of flame propagation.

As a result of the yarn structure, the yarn and in particular the fabric produced with it is inherently flame-retardant, so that in an advantageous manner and favorably under the aspect of costs, no flame-retardant finishing of the fabric is required.

At the same time, a fabric produced with the described yarn has comparatively comfortable wearing properties, since the sheath consists largely of synthetic cellulose, which advantageously has good properties with regard to moisture absorption. Furthermore, this material has the advantage of good dyeability and printability.

Due to its specific construction, the fabric according to the invention retains its textile properties even when exposed to heat. Even after prolonged exposure (5 min) at higher temperatures (260° C.), it does not become brittle, retains its material flexibility and thus meets the requirements of EN ISO 15384, tested according to EN ISO 17493. In contrast, a fabric that has a PES core, for example, (the sheath has an identical composition to that described herein), becomes brittle and “crumbles”.

The described sheath can be spun around the core, followed by plying. Furthermore, the sheath ensures that the polyamide in the core is protected when the fabric is exposed to flames in that the polyamide core neither burns, glows nor melts and also has no melting particles. Consequently, a polyamide proportion of up to 35%, which is favorable for strength, can be realized without the potential problems described.

(Para-)Aramid in the sheath also has a positive effect, namely a reduction in heat transmission due to radiation. Kevlar, Twaron, etc. can be used as para-aramid. The para-aramid is thus used as a heat insulator and as a blocker when exposed to flames; in other words, the fabric does not ‘break up’.

Overall, the strength properties are therefore concentrated on the core and the favorable properties with regard to wearing comfort and printability on the sheath. Furthermore, the above-stated requirements with regard to outdoor firefighting are met and, in addition, the new fabric is comparatively inexpensive.

Preferred embodiments are described in the further claims.

Advantageously, it is preferred with regard to wearing comfort that a proportion of at least 83%, in particular at least 91%, of synthetic cellulose FR, in other words viscose FR, is present in the sheath, i.e. on the outer surface of the yarn.

Advantageously, the fabric according to the invention, which consists of the yarn described above, has a strength in the warp direction according to ASTM D 5034 or EN ISO 13934-1 from 900 to 1100, in particular at least 1000 N/ 5 cm and/or a maximum tensile strength in the weft direction of 800-1000, in particular at least 900 N/ 5 cm. The stipulated strength can thus be achieved.

Furthermore, the tear growth resistance is increased by means of a ripstop weave.

Preferably, the tear growth resistance in the warp direction and/or weft direction is at least 50 N according to ASTM D 2261 or EN ISO 13937-2.

At the same time, the weight of the fabric according to EN 12127 can be kept comparatively low at 180-200, in particular around 190 g/m².

This also applies to the change in dimension after five household washing cycles according to AATCC 135 or EN ISO 5077/6330 of 2% in the warp direction and/or weft direction.

As already stated, the fabric produced according to the invention meets the requirements of the EN ISO 15384 standard tested according to EN ISO 15025 method A and method B. In other words, the afterglow time and the afterburning time are a maximum of 2 seconds. No burning or melting particle detachment may occur in any sample. Furthermore, no holes of 5 mm or more in any direction may occur in any sample.

As regards the heat transmission values according to EN ISO 6942:2002 using method B=20 kW/m², a value of RHTI 24, i.e. an increase in the temperature on the rear side of the fabric by 24 K (K=Kelvin), is reached only after 13 seconds, in any case more than 11 seconds, both when new and after washing. An increase in the temperature on the rear side of the fabric by 12 K, i.e. RHTI 12, takes place at at least 6 seconds and in any case at more than 4 seconds, and the average degree of permeability is less than 55% and in any case a maximum of 70%. Thus, the fabric according to the invention advantageously reaches the target values according to EN ISO 15384:2022.

The abrasion resistance according to EN ISO 12947-2 under a load of 12 kPa is also very high, namely at least 140,000 cycles, while comparable fabrics for the purpose of protective clothing for firefighting in open terrain have an abrasion resistance of approximately 60,000 cycles.

Overall, the use of a fabric produced according to the invention thus advantageously provides protective clothing for firefighting in open terrain, so that it complies with EN ISO 15384. This also applies to EN 16689:2017. These standards also stipulate certain color values and luminance factors after exposure, which lead to high visibility according to EN ISO 20471. The fabric produced according to the invention with the reduced para-aramid content also meets these requirements in the standard in an advantageous manner.

1. Fabric with a core yarn with a core consisting of 100% polyamide and a sheath of synthetic cellulose FR, aramid, in particular para-aramid, and antistatic fibers, the yarn optionally containing a total of 1-12% aramid, in particular para-aramid, 52-70% synthetic cellulose FR, 26-35% polyamide, and optionally up to 2% antistatic fibers.

2. Fabric according to claim 1,
characterized in that
the sheath contains at least 83% viscose FR as cellulose FR.

3. Fabric according to claim 1 , characterized in that the sheath contains at least 91% viscose FR.

4. Fabric according to claim 1,
characterized in that
it has a tensile strength of 900 to 1100 N/ 5 cm in the warp direction and/or 800 to 1000 N/5 cm in the weft direction according to ASTM D 5034 or EN ISO 13934-1.

5. Fabric according to claim 1,
characterized in that
it has a ripstop weave.

6. Fabric according to claim 1,
characterized in that
it has a tear growth resistance in the warp direction and/or weft direction of at least 50 N according to ASTM D 2261 or EN ISO 13937-2.

7. Fabric according to claim 1,
characterized in that
it has a surface weight of 180-200, in particular about 190 g/m².

8. Fabric according to claim 1,
characterized in that
after five household washing cycles, its dimensions in the warp direction and/or weft direction change by a maximum of 2% according to AATCC 135 or EN ISO 5077/6330.

9. Fabric according to claim 1,
characterized in that
it meets the requirements of the EN ISO 15384 standard tested according to EN ISO method A and method B.

10. Fabric according to claim 1,
characterized in that
both when new and after washing, according to EN ISO 6942:2002, it has an RHTI 24 value of at least 13 seconds and/or an RHTI 24-RHTI12 of at least 6 seconds and/or an average degree of permeability according to EN ISO 15384:2022 and a maximum of 55%.

11. Fabric according to claim 1,
characterized in that
it has an abrasion resistance according to EN ISO 12947-2, under a load of 12 kPa, of at least 140,000 cycles.

12. Use of a fabric according to claim 1 in protective clothing for firefighting in open terrain and/or for technical rescue.
